(19) United States
(12) Patent Application Publication
(10) Pub. No.: US 2024/0217847 A1
(43) Pub. Date: Jul. 4, 2024

(54) COMPOSITE FLOCCULANT FOR TREATING LOW-TEMPERATURE AND LOW-TURBIDITY WATER AND PREPARATION METHOD THEREOF

(71) Applicant: Jilin Jianzhu University, Changchun (CN)

(72) Inventors: Zhisheng LIU, Changchun (CN); Jianhui WANG, Changchun (CN); Guang LI, Changchun (CN); Zhi LIU, Changchun (CN); Xiaoyu ZHANG, Changchun (CN)

(21) Appl. No.: 18/509,582

(22) Filed: Nov. 15, 2023

(30) Foreign Application Priority Data
Dec. 30, 2022 (CN) 202211723516.X

(51) Int. Cl. C02F 1/52

(52) U.S. Cl. CPC C02F 1/5236; C02F 2103/007

(57) ABSTRACT

A composite flocculant for treating low-temperature and low-turbidity water and a preparation method thereof are provided. The composite flocculant includes nanometer modified natural mordenite, sodium silicate solution, nanometer natural pyrrhotite and nanometer ferroferric oxide. The preparation method includes: adding natural mordenite into a sodium chloride solution for a primary modification, cleaning and drying, and grinding and winnowing the nanometer primary modified zeolite; adding dilute hydrochloric acid solution into the nanometer primary modified zeolite, stirring to obtain mixed liquid of secondary modified zeolite and dilute hydrochloric acid solution; adding industrial-grade sodium silicate solution into the mixed liquid of the secondary modified zeolite and dilute hydrochloric acid solution, and diluting to obtain a mixed liquid of modified zeolite compound activated silicic acid; adding nanometer natural pyrrhotite and nanometer ferroferric oxide into the mixed liquid of modified zeolite compound activated silicic acid, and stirring rapidly and ultrasonic oscillating.

### CROSS-REFERENCE TO RELATED APPLICATIONS

This application claims priority to Chinese Patent Application No. 202211723516.X, filed on Dec. 30, 2022, the contents of which are hereby incorporated by reference.

### TECHNICAL FIELD

The present application belongs to the technical field of urban water environment treatment and sewage treatment, and particularly relates to a composite flocculant for treating low-temperature and low-turbidity water and a preparation method thereof.

### BACKGROUND

Water environment management is one of the important tasks in the battle against pollution in China. Flocculation is a very important and classic water treatment technology, which realizes water purification through the principles of electric neutralization, net capture and adsorption bridging. Flocculation technology is able to remove suspended and colloidal substances in water in a short time and restore the transparency of water, but the low removal efficiency of organic matters and ammonia nitrogen has always been one of the difficult problems to be solved. At present, the commonly used flocculants are aluminum salts and iron salts, such as polyaluminum chloride, aluminum sulfate, ferric chloride, polymeric iron and so on. These flocculants have been widely used in water treatment, but the sedimentation time is long under conditions of low temperatures and low turbidity, and the efficiency of removing pollutants such as organic matter and ammonia nitrogen is not high. Therefore, it will be a new way of water treatment flocculation technology to develop a flocculant which has high efficiency in removing organic matter, ammonia nitrogen and total phosphorus in water, and is able to accelerate sedimentation for mud-water separation under its own gravity, especially for low-temperature and low-turbidity water.

### SUMMARY

In view of the problems existing in the prior art, the present application provides a composite flocculant for treating low-temperature and low-turbidity water and a preparation method thereof.

In order to achieve the above objective, the present application proposes the following technical scheme.

A preparation method of the composite flocculant for treating low-temperature and low-turbidity water includes following steps:
S1, carrying out a secondary modification on a nanometer primary modified zeolite by using dilute hydrochloric acid to obtain secondary modified zeolite, then adding a sodium silicate solution into the dilute hydrochloric acid solution containing the secondary modified zeolite, stirring, diluting by times with distilled water, continuing stirring, and curing for 1-2 days to obtain modified zeolite compound activated silicic acid; and
S2, adding nanometer natural pyrrhotite and nanometer ferroferric oxide into the modified zeolite compound activated silicic acid, stirring, and ultrasonically oscillating for 1-2 hours to obtain the composite flocculant for treating low-temperature and low-turbidity water.

Optionally, the diluting by times in the S1 is diluting by 3.5-4 times.

Optionally, the preparation method of the nanometer primary modified zeolite in the S1 includes the following steps:
step 1), adding natural mordenite as a raw material into a sodium chloride solution, and carrying out water bath heating treatment under the stirring state to obtain a primary modified zeolite; and
step 2), grinding and winnowing the primary modified zeolite to obtain the nanometer primary modified zeolite.

Optionally, in the step 1), the particle size of the natural mordenite is 1-3 mm; a dosage ratio of the natural mordenite to the sodium chloride solution with the concentration of 100 g/L (gram per liter) is 1 g: 20 mL (milliliter); a temperature of the water bath heating is 70-80° C., and a duration of the water bath heating is 3-4 hours.

Optionally, a particle size of the nanometer primary modified zeolite in the step 2) is 40-80 nm (nanometer).

Optionally, a dosage ratio of the nanometer primary modified zeolite to the dilute hydrochloric acid with a volume fraction of 10% in the S1 is 1 g: 10 mL.

Optionally, the sodium silicate solution is an industrial-grade sodium silicate solution. The nanometer natural pyrrhotite has a particle size of 20-30 nm. The nanometer ferroferric oxide has a particle size of 20-30 nm.

The present application also provides a composite flocculant for treating low-temperature and low-turbidity water prepared by the preparation method mentioned above. The composite flocculant includes secondary modified zeolite, dilute hydrochloric acid, sodium silicate solution, nanometer natural pyrrhotite and nanometer ferroferric oxide, and the dosage ratio of the nanometer primary modified zeolite, the dilute hydrochloric acid, the sodium silicate solution, the nanometer natural pyrrhotite and the nanometer ferroferric oxide is 2 g: 20 mL: 12 mL: 1 g: 1 g.

The present application also provides an application of a composite flocculant for treating low-temperature and low-turbidity wastewater.

Compared with the prior art, the present application has following beneficial effects.

Firstly, the composite flocculant is suitable for side purification of polluted river water, especially low-temperature and low-turbidity river water. It has the characteristics of fast flocculation and short sedimentation time and high purification efficiency, and is able to oxidize organic matters and remove nitrogen and phosphorus, and the removal rate of ammonia nitrogen is able to reach more than 30%.

Secondly, the composite flocculant is also suitable for solving the problem of sludge leakage in the secondary sedimentation tank caused by sludge bulking in winter in urban sewage treatment plants. When the composite flocculant is added into the inlet water of the secondary sedimentation tank, the sludge sedimentation ratio is reduced from 85% to 42% in 30 minutes, and at the same time, the phosphorus removal function is strengthened.

Lastly, the composite flocculant may be used alone or in combination with aluminum salt coagulant or ferric salt coagulant.

### BRIEF DESCRIPTION OF THE DRAWINGS

FIG. 1 is a flow chart of a preparation method of a composite flocculant for treating low-temperature and low-turbidity water according to the present application.

FIG. 2 is a flow chart of a preparation method of nanometer primary modified zeolite.

### DETAILED DESCRIPTION OF THE EMBODIMENTS

A number of exemplary embodiments of the present application will now be described in detail, which should not be considered as a limitation of the present application, but should be understood as a more detailed description of some aspects, characteristics and embodiments of the present application.

It should be understood that the terminology described in present application is only for describing specific embodiments and is not used to limit present application. In addition, for the numerical range in present application, it should be understood that each intermediate value between the upper limit and the lower limit of the range is also specifically disclosed. The intermediate value within any stated value or stated range and every smaller range between any other stated value or intermediate value within the stated range are also included in present application. The upper and lower limits of these smaller ranges may be independently included or excluded from the range.

Unless otherwise specified, all technical and scientific terms used herein have the same meaning as commonly understood by one of ordinary skill in the art described in present application. Although present application only describes the preferred methods and materials, any methods and materials similar or equivalent to those described herein can also be used in the implementation or testing of present application. All documents mentioned in this specification are incorporated by reference to disclose and describe methods and/or materials related to the documents. In case of conflict with any incorporated document, the contents of this specification shall prevail.

It is obvious to those skilled in the art that many improvements and changes may be made to the specific embodiments of the specification of present application without departing from the scope or spirit of present application. Other embodiments will be obvious to the skilled person from the description of present application. The specification and embodiments of present application are only exemplary.

The terms “including”, “comprising”, “having” and “containing” used in this article are all open terms, which means including but not limited to.

The raw materials used in present application are all commercially available.

The “room temperature” mentioned in present application means 25±2° C. unless otherwise specified.

A composite flocculant for treating low-temperature and low-turbidity water includes nanometer primary modified zeolite, dilute hydrochloric acid, sodium silicate solution, nanometer natural pyrrhotite and nanometer ferroferric oxide, and the dosage ratio of the nanometer primary modified zeolite, the dilute hydrochloric acid, the sodium silicate solution, the nanometer natural pyrrhotite and nanometer ferroferric oxide is 2 g: 20 mL: 12 mL: 1 g: 1 g.

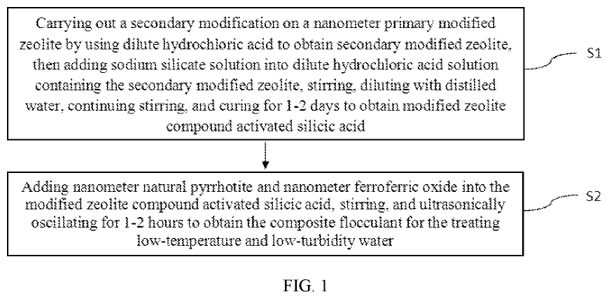

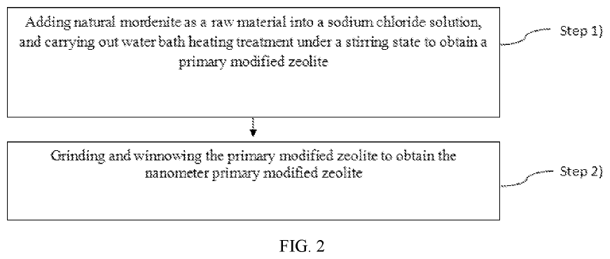

The present application also provides a preparation method of a composite flocculant for treating low-temperature and low-turbidity water, as shown in FIG. 1, including the following steps:
S1, the preparation method of nanometer modified natural mordenite includes the following steps, as shown in FIG. 2:
step 1), 100 g of natural mordenite as a raw material with a particle size of 1-3 mm is added into 2 L of sodium chloride solution with a concentration of 100 g/L, the water bath temperature is 70-80° C., and stirring is carried out at a medium speed (400 rpm) for 3-4 hours. After filtration, washing with distilled water is carried out for 3-5 times, drying is carried out at 80-90° C. in an oven to constant weight, and cooling is carried out to room temperature to obtain the primary modified zeolite;
step 2), the primary modified zeolite is subjected to grinding and winnowing to obtain nanometer primary modified zeolite, and the equivalent particle size is nanometer; and
step 3), 100 g of nanometer primary modified zeolite into is slowly added into 1 L of dilute hydrochloric acid solution with a volume fraction of 10%, and stirred for 2-3 hours at a medium speed (a rotating speed of 400 rpm) at room temperature to obtain secondary modified zeolite.

The function of dilute hydrochloric acid is to modify the nanometer primary modified zeolite for the second time. The secondary modified zeolite obtained after modification contains both the modified zeolite modified by a second modification and dilute hydrochloric acid itself. When dilute hydrochloric acid contacts with sodium silicate solution along with the secondary modified zeolite, it activates sodium silicate solution into “activated silicic acid”. In other words, the dilute hydrochloric acid both modifies zeolite and activates sodium silicate solution at the same time.
S2, 600 mL of industrial-grade sodium silicate solution is rapidly added into the secondary modified zeolite (containing dilute hydrochloric acid) under the condition of rapid stirring (a rotating speed of 800 rpm), rapidly stirred (a rotating speed of 800 rpm) for 2-3 hours, diluted by 3.5-4 times with distilled water, then stirred at medium speed (rotating speed of 400 rpm) for 1-2 hours, and subjected to curing for 1-2 days to complete silicification activation of sodium silicate solution, thus obtaining modified zeolite compound activated silicic acid.
S3, 50 g of nanometer natural pyrrhotite and 50 g of nanometer ferroferric oxide are added into the modified zeolite compound activated silicic acid, rapidly stirred (rotating speed of 800 rpm) for 1-2 hours, and ultrasonically oscillated for 1-2 hours to obtain the composite flocculant for treating low-temperature and low-turbidity water.

In an embodiment, in the step 1), a dosage ratio of the natural mordenite to the sodium chloride solution with a concentration of 100 g/L is 1 g: 20 mL.

In an embodiment, in the step 2), a particle size of the nanometer primary modified zeolite is 40-80 nm.

In an embodiment, in the step 3), a volume fraction of the dilute hydrochloric acid is 10%.

In an embodiment, when natural pyrrhotite and ferroferric oxide are selected, they are respectively ground and winnowed, and the equivalent particle size of the ground and winnowed natural pyrrhotite and ferroferric oxide is nanometer. The nanometer natural pyrrhotite has a particle size of 20-30 nm. The nanometer ferroferric oxide has a particle size of 20-30 nm.

The present application also provides an application of a composite flocculant for treating low-temperature and low-turbidity wastewater.

The following embodiments serve as a further explanation of the technical scheme of present application.

### Embodiment 1

A preparation method of a composite flocculant for treating low-temperature and low-turbidity water includes the following specific steps:
S1, the preparation method of nanometer modified natural mordenite includes the following steps:
step 1): 1000 g of natural mordenite as a raw material with a particle size of 1-3 mm is added into 20 L of sodium chloride solution with a concentration of 100 g/L, the water bath temperature is 70° ° C., and stirring is carried out for 3 hours at a medium speed (a rotating speed is 400 rpm). After filtration, washing with distilled water is carried out for 4 times, drying is performed at 85° C. in an oven to a constant weight, and cooling is carried out to room temperature, so as to obtain the primary modified zeolite;
step 2), the primary modified zeolite is subjected to grinding and winnowing to obtain the nanometer primary modified zeolite, where the equivalent particle size is nanometer, and the specific average particle size is 60 nm; and
step 3), 1000 g of nanometer primary modified zeolite is slowly added into 10 L of dilute hydrochloric acid solution with a volume fraction of 10%, and stirred for 2 hours at a medium speed (a rotating speed of 400 rpm) at a room temperature to obtain secondary modified zeolite (containing dilute hydrochloric acid).
S2, 6000 mL of industrial-grade sodium silicate solution is rapidly added into the above-mentioned secondary modified zeolite (containing dilute hydrochloric acid) under the condition of rapid stirring (rotating speed of 800 rpm), rapidly stirred (rotating speed of 800 rpm) for 2 hours, diluted by 4 times with distilled water, then stirred at medium speed (rotating speed of 400 rpm) for 1.5 hours, and subjected to curing for 1 day to complete silicic acid activation of sodium silicate solution, thus obtaining modified zeolite compound activated silicic acid.
S3, 500 g of nanometer natural pyrrhotite with an average particle size of 30 nm and 500 g of nanometer ferroferric oxide with an average particle size of 30 nm are added into the modified zeolite compound activated silicic acid, rapidly stirred (rotating speed of 800 rpm) for 1 hour, and ultrasonically oscillated for 1.5 hours to obtain the composite flocculant for treating low-temperature and low-turbidity water.

### Embodiment 2

A preparation method of a composite flocculant for treating low-temperature and low-turbidity water includes the following specific steps:
S1, the preparation method of nanometer modified natural mordenite includes the following steps:
step 1): 1000 g of natural mordenite as a raw material with a particle size of 1-3 mm is added into 20 L of sodium chloride solution with a concentration of 100 g/L, the water bath temperature is 75° C., and stirring is carried out for 4 hours at a medium speed (rotating speed is 400 rpm). After filtration, washing with distilled water is carried out for 5 times, drying is performed at 90° C. in an oven to constant weight, and cooling is carried out to room temperature, so as to obtain the primary modified zeolite;
step 2), the primary modified zeolite is subjected to grinding and winnowing to obtain the nanometer primary modified zeolite, where the equivalent particle size is nanometer, and the specific average particle size is 60 nm; and
step 3), 1000 g of nanometer primary modified zeolite is slowly added into 10 L of dilute hydrochloric acid solution with a volume fraction of 10%, and stirred for 3 hours at medium speed (rotating speed of 400 rpm) at a room temperature to obtain secondary modified zeolite (containing dilute hydrochloric acid).
S2, 6000 mL of industrial-grade sodium silicate solution is rapidly added into the above-mentioned secondary modified zeolite (containing dilute hydrochloric acid) under the condition of rapid stirring (rotating speed of 800 rpm), rapidly stirred (rotating speed of 800 rpm) for 3 hours, diluted by 3.5 times with distilled water, then stirred at medium speed (rotating speed of 400 rpm) for 2 hours, and subjected to curing for 2 days to complete silicic acid activation of sodium silicate solution, thus obtaining modified zeolite compound activated silicic acid.
S3, 500 g of nanometer natural pyrrhotite with an average particle size of 30 nm and 500 g of nanometer ferroferric oxide with an average particle size of 30 nm are added into the modified zeolite compound activated silicic acid, rapidly stirred (rotating speed of 800 rpm) for 2 hours, and ultrasonically oscillated for 2 hours to obtain the composite flocculant for treating low-temperature and low-turbidity water.

### Comparative Embodiment 1

The difference from the embodiment 1 is that the nanometer natural mordenite modified by hydrochloric acid in the S1 is replaced by nanometer natural mordenite. The preparation method of nanometer natural mordenite is as follows: the natural mordenite as a raw material with a particle size of 1-3 mm is ground and winnowed, and the equivalent particle size is nanometer, and the specific average particle size is 60 nm.

### Comparative Embodiment 2

The difference from the embodiment 1 is that the nanometer natural mordenite modified by hydrochloric acid in S1 is replaced by nanometer primary modified zeolite. Specifically, step 3) is not carried out in the preparation process of nanometer modified natural mordenite.

### Comparative Embodiment 3

Comparative embodiment 3 is same as embodiment 1, but the difference is nanometer ferroferric oxide is not added in S3.

### Comparative Embodiment 4

Ferric salt coagulant purchased from the market is used.

### Application Embodiment 1

### Purifying the Polluted River Water

1 L of polluted river water worsen than grade V with a water temperature of 5° C. is taken, in which the pollution content is: chemical oxygen demand 50 mg/L, ammonia nitrogen 3.2 mg/L and total phosphorus 0.55 mg/L. The composite flocculants in the embodiments, comparative embodiments and combined flocculant in the control group (the dosage of 30 mg shown in the control group in the table refers to: 20 mg of the composite flocculant prepared in embodiment 1+10 mg of the ferric salt coagulant purchased in the market) are added, rapid stirring (rotating speed of 600 rpm) is carried out for 1 minute, slow stirring (rotating speed of 200 rpm) is carried out for 2 minutes, and settling is carried out for 20 minutes. The supernatant is taken and the content of pollutants is measured. The results are shown in Table 1.

TABLE 1

| | | Pollution content(mg/L) | | |
|---|---|---|---|---|
| | Dosage/ | Chemical | Ammonia | Total |
| Items | mg | oxygen demand | nitrogen | phosphorus |
| Embodiment 1 | 15 | 39 | 1.8 | 0.35 |
| Embodiment 1 | 30 | 32 | 1.2 | 0.26 |
| Embodiment 2 | 30 | 31 | 1.2 | 0.25 |
| Comparative | 30 | 34 | 2.5 | 0.29 |
| embodiment 1 | | | | |
| Comparative | 30 | 33 | 1.9 | 0.29 |
| embodiment 2 | | | | |
| Comparative | 30 | 42 | 1.5 | 0.28 |
| embodiment 3 | | | | |
| Comparative | 30 | 45 | 3.0 | 0.36 |
| embodiment 4 | | | | |
| Control group | 30 | 35 | 1.4 | 0.30 |

It can be seen from Table 1 that the removal rate of ammonia nitrogen reaches 43% and the highest removal rate of ammonia nitrogen reaches 62% when the composite flocculant prepared in embodiment 1 of present application is used for sewage treatment.

### Application Embodiment 2

Solve the problem of mud running in the secondary sedimentation tank of sewage treatment plant.

The mixed liquid at the end of the aerobic tank with sludge bulking in winter in a town sewage treatment plant is taken, with water temperature of 7-8° C., and is divided into two groups: group 1: the sludge settling velocity is 85% after the mixed liquid is poured into a 1 L measuring cylinder for static settlement for 30 minutes. Group 2: 20 mg of the composite flocculant prepared in embodiment 1 of present application is added to 1 L mixed liquid, stirred evenly, poured into 1 L measuring cylinder for static settlement for 30 minutes, and the sludge settling velocity is 42%. Therefore, in practical application, adding it at the inlet of the secondary sedimentation tank of sewage treatment plant is able to solve the problem of sludge running from the secondary sedimentation tank.

The above is only the preferred embodiments of present application, and it is not used to limit present application. Any modification, equivalent substitution and improvement made within the spirit and principle of present application should be included in the protection scope of present application.

What is claimed is:

1. A preparation method of a composite flocculant for treating low-temperature and low-turbidity water, comprising following steps:
S1, carrying out a secondary modification on a nanometer primary modified zeolite by using dilute hydrochloric acid to obtain secondary modified zeolite, then adding a sodium silicate solution into the dilute hydrochloric acid solution containing the secondary modified zeolite, stirring, diluting by times with distilled water, continuing stirring, and curing for 1-2 days to obtain modified zeolite compound activated silicic acid; and
S2, adding nanometer natural pyrrhotite and nanometer ferroferric oxide into the modified zeolite compound activated silicic acid, stirring, and ultrasonically oscillating for 1-2 hours to obtain the composite flocculant for treating the low-temperature and low-turbidity water.

2. The preparation method according to claim 1, wherein the diluting by times in the S1 is diluting by 3.5-4 times.

3. The preparation method according to claim 1, wherein a preparation method of the nanometer primary modified zeolite in the S1 comprises following steps:
step 1), adding natural mordenite as a raw material into a sodium chloride solution, and carrying out water bath heating treatment under a stirring state to obtain a primary modified zeolite; and
step 2), grinding and winnowing the primary modified zeolite to obtain the nanometer primary modified zeolite.

4. The preparation method according to claim 3, wherein in the step 1), a particle size of the natural mordenite is 1-3 mm; a dosage ratio of the natural mordenite to the sodium chloride solution with a concentration of 100 g/L is 1 g: 20 mL; a temperature of the water bath heating is 70-80° C., and a duration of the water bath heating is 3-4 hours.

5. The preparation method according to claim 3, wherein a particle size of the nanometer primary modified zeolite in the step 2) is 40-80 nm.

6. The preparation method according to claim 1, wherein a volume fraction of the dilute hydrochloric acid in the S1 is 10%.

7. The preparation method according to claim 1, wherein the sodium silicate solution is an industrial-grade sodium silicate solution; the nanometer natural pyrrhotite has a particle size of 20-30 nm; and the nanometer ferroferric oxide has a particle size of 20-30 nm.

8. A composite flocculant for treating low-temperature and low-turbidity water prepared by the preparation method according to claim 1, wherein the composite flocculant comprises the nanometer primary modified zeolite, the dilute hydrochloric acid, the sodium silicate solution, the nanometer natural pyrrhotite and the nanometer ferroferric oxide, wherein a dosage ratio of the nanometer primary modified zeolite, the dilute hydrochloric acid, the sodium silicate solution, the nanometer natural pyrrhotite and the nanometer ferroferric oxide is 2 g: 20 mL: 12 mL: 1 g: 1 g.

9. An application of the composite flocculant for treating the low-temperature and low-turbidity water according to claim 8 in treating low-temperature and low-turbidity wastewater.
